(19) United States
(12) Patent Application Publication
(10) Pub. No.: US 2013/0286282 A1
(43) Pub. Date: Oct. 31, 2013

(54) Camera Module and Manufacturing Method Thereof

(71) Applicant: Katsumi Yamamoto, Tokyo (JP)

(72) Inventor: Katsumi Yamamoto, Tokyo (JP)

(73) Assignee: Toppan Printing Co., Ltd., Tokyo (JP)

(21) Appl. No.: 13/458,985

(22) Filed: Apr. 27, 2012

(51) Int. Cl. H04N 5/225; B23P 11/00

(52) U.S. Cl. 348/374; 29/428; 348/E05.025

(57) ABSTRACT

In order to prevent a flare phenomenon of a camera module manufactured by a wafer process, there is provided a camera module including at least one lens sheet layered on a solid-state imaging device through a glass spacer, wherein an inner side wall and upper and lower surfaces or a side wall of at least the spacer is coated with a light shielding layer made of metal or black colored resin. Here, at least a peripheral portion of a lens of the lens sheet is coated with the light shielding layer.

### BACKGROUND OF THE INVENTION

1. Field of the Invention

The present invention relates to a camera module, and more particularly, to an outside light shielding technique of a camera module which is mounted in a mobile phone.

2. Background Art

Most mobile phones have a camera mounted. Such a camera employs a solid-state imaging device of a charge coupled device (CCD) type or a complementary metal oxide semiconductor (CMOS) type and is assembled with a lens and the like to form a camera module, which is mounted in a mobile phone.

As shown in FIGS. 5A and 5B, two cameras are mounted in a mobile phone 40. A first camera 41 is a high resolution camera having about 5,000,000 to 10,000,000 pixels which are the same as the number of pixels of a normal digital still camera. A second camera 42 has about 100,000 to 300,000 pixels and is mainly used for moving picture photographing. The second camera 42 is used for a telephone call in a television phone or the like where the face or the like of a caller or the other party is displayed on a display screen 44 by operation of an input button 43.

As shown in FIG. 6, a camera module in the related art is a camera module 50 which includes a solid-state imaging device 51 and about two or three sheets of lenses 52a and 52b. The entire camera module is supported by a camera frame 53 made of synthetic resin. The camera frame 53 is colored black to shield peripheral light. A color filter for color separation and a micro-lens for light condensation are formed for each pixel on a light receiving element surface of the solid-state imaging device 51. Further, in this camera module, the front surface of the solid-state imaging device 51 on the side of the light receiving element surface is protected by a cover glass 54.

As shown in FIG. 6, the solid-state imaging device 51 of the camera module 50 is electrically connected to electrodes 56a and 56b of conductive layers 56 on a printed circuit board 55 through wire bonding or connection terminals of a ball grid array (BGA) type or the like, so that image information which is converted into an electric signal is extracted.

However, since the camera module 50 as shown in FIG. 6 employs the camera frame 53 made of synthetic resin, it is difficult to automatically mount the camera module 50 by a solder reflow process. Further, due to the thickness of the printed circuit board 55, longitudinal enlargement is hard to avoid, which interferes with a mobile phone being thin and light-weight.

In this regard, for realization of a light-weight and thin camera module, a structure which can be manufactured by a wafer process has been proposed. A camera module 60 shown in FIG. 7 is an example thereof. In FIG. 7, a silicon substrate 1 which is a solid-state imaging device is provided with a color filter 16 for color separation and a micro-lens 17 for light condensation for each pixel on a light receiving element surface which is an upper surface thereof. An electric signal of image information obtained in the solid-state imaging device is extracted to a rear surface of the silicon substrate through a conductive material 2 which fills in a through-silicon via or coats the inner wall of the through-silicon via, passes through an insulating layer 3 and a conductive layer 4 which are connected thereto and are patterned, and is output to an external circuit through a connection terminal 5 of a BGA type.

On the upper side of the silicon substrate 1, a light receiving area is sealed by attaching a sealing glass plate 7 through a dam 6. A thickness of the dam 6 is about 50 μm. A first lens sheet 14 where lenses 9a and 9b made of transparent resin are formed on front and rear surfaces of a first lens substrate 9 is layered above the sealing glass plate 7 through a first spacer 8 made of glass. Further, a second lens sheet 15 where lenses 11a and 11b made of transparent resin are formed on front and rear surfaces of a second lens substrate 11 is layered above the first lens sheet 14 through a second spacer 10 made of glass. In FIG. 7, the first lens sheet 14 is a concave lens, and the second lens sheet 15 is a convex lens. The lenses made of transparent resin are formed by a fine molding method or a photolithography method. Finally, a cover glass plate 13 is attached thereto through a third spacer 12. In many cases, the cover glass plate 13 also has an infrared cut glass function.

Only one camera module 60 is shown in FIG. 7, but in an actual manufacturing process, the camera module 60 is manufactured as one camera module through a process where a glass plate having a diameter of 20 to 30 cm is combined with a silicon wafer having a diameter of 20 to 30 cm to be processed and through a final dicing process for individual cutting. For example, in the case of the second camera mounted in the mobile phone, the size of the camera module 60 shown in FIG. 7 is approximately 3 mm×3 mm, which is small, and thus, 1,500 to 2,800 camera modules can be simultaneously manufactured from one sheet of wafer having a diameter of 20 cm.

However, the camera module 60 shown in FIG. 7 has a problem to be solved. That is, each of the spacers 8, 10 and 12 and the lens substrates 9 and 11 layered on the silicon substrate 1 is made of glass or plastic, and should thus have a thickness of about 0.4 mm in order to maintain sufficient strength to undergo the wafer process. Thus, the height of the lens portion of the camera module 60 is correspondingly increased. Further, since glass or plastic has light transmissive characteristics, outside light may enter through a side wall of the layered structure.

In a case where outside light rays are incident on the camera module at an angle, these light rays may cause a flare or fogging phenomenon. This is a phenomenon in which a white blur or an unnecessary light image is generated in a photographed image. In order to prevent this flare phenomenon, as shown in FIG. 8, a technique has been proposed in which a shielding lens tube 18 made of metal is mounted to the camera module 60 to shield light incident through the side wall.

However, considering that the size of the silicon substrate 1 of the camera module is approximately 3 mm×3 mm, in order to mount the tubular shielding body to such a small camera module in a fixed manner, time-consuming and difficult processes and work are necessary by either manual means or mechanical means. Thus, it is difficult to achieve the advantage of mass production through the wafer process, and to achieve cost reduction.

JP-A-2008-124919 and JP-A-2002-214436 are examples of the above-described techniques in the related art.

### SUMMARY OF THE INVENTION

An advantage of some aspects of the invention is to provide a structure of a camera module including an outside light shielding layer, which is able to be simply manufactured in a manufacturing process, and a manufacturing method thereof, which provides a solution to the flare phenomenon in a camera module manufactured by a wafer process.

According to a first aspect of the invention, there is provided a camera module including at least one lens sheet layered on a solid-state imaging device through a glass spacer, wherein an inner side wall and upper and lower surfaces or a side wall of at least the spacer is coated with a light shielding layer made of metal or black colored resin.

According to a second aspect of the invention, in the camera module according to the first aspect of the invention, at least a peripheral portion of a lens of the lens sheet may be coated with the light shielding layer.

According to a third aspect of the invention, in the camera module according to the first or second aspect of the invention, the light shielding layer made of metal may be formed by electroless plating or vacuum deposition.

According to a fourth aspect of the invention, in the camera module according to the first or second aspect of the invention, the light shielding layer made of black colored resin may be formed by spray coating or spin coating.

According to a fifth aspect of the invention, in the camera module according to any one of the first to fourth aspects of the invention, the optical density of the light shielding layer may be 2.0 or more.

According to a sixth aspect of the invention, there is provided a manufacturing method of the camera module according to any one of the first to fifth aspects including at least one lens sheet layered on a solid-state imaging device through a glass spacer, the method including: (a) attaching an easily detachable protection film onto upper surfaces of the camera modules and adhering an extensible film which includes an adhesive layer onto lower surfaces of the camera modules; (b) cutting the individual camera modules along a cutting line between the camera modules; (c) enlarging a gap between the respective camera modules by extending the extensible film after the cutting; (d) forming a light shielding layer on a side wall and upper and lower surfaces or the side wall of each of the camera modules where the gap is enlarged; and (e) detaching the easily detachable protection film from the upper surfaces of the camera modules and the extensible film including the adhesive layer from the lower surfaces thereof.

According to a seventh aspect of the invention, there is provided a manufacturing method of the camera module according to any one of the first to fifth aspects including at least one lens sheet layered on a solid-state imaging device through a glass spacer, the method including: (a) attaching an easily detachable protection film onto upper surfaces of the camera modules; (b) cutting a silicon wafer where the respective camera modules are formed, up to an intermediate portion of the silicon wafer in a thickness direction thereof, along a cutting line between the camera modules; (c) forming a light shielding layer on a side wall and upper and lower surfaces or the side wall of each of the camera modules, which is cut and exposed, after the cutting up to the intermediate portion of the silicon wafer in the thickness direction thereof; and (d) performing full cutting along the cutting line between the camera modules and detaching the easily detachable protection film from the upper surfaces of the camera modules.

According to the invention, there is provided a structure of a camera module in which a shielding lens tube for prevention of the flare phenomenon is not necessary, and a manufacturing method thereof, which provides a solution to the flare phenomenon in a camera module manufactured by a wafer process. Further, the manufacturing method according to the invention is suitable for mass production, which results in manufacturing cost reduction.

### BRIEF DESCRIPTION OF THE DRAWINGS

FIG. 1 is a cross-sectional view illustrating a camera module which includes a light shielding film according to an embodiment of the invention.

FIGS. 2A to 2D are cross-sectional process diagrams schematically illustrating an example of a process of forming a spacer connection body and forming a light shielding layer on the spacer connection body.

FIGS. 3A to 3E are partial cross-sectional views schematically illustrating an example of a camera module manufacturing process according to an embodiment of the invention.

FIGS. 4A and 4B are partial cross-sectional views schematically illustrating an example of a camera module manufacturing process according to an embodiment of the invention.

FIG. 5 is a diagram schematically illustrating a state where a camera module is mounted on a mobile phone.

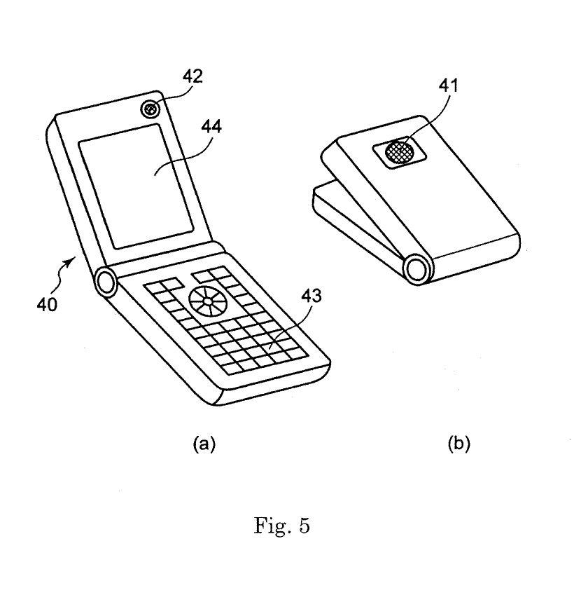

FIG. 6 is a cross-sectional view illustrating a structure of a camera module in the related art.

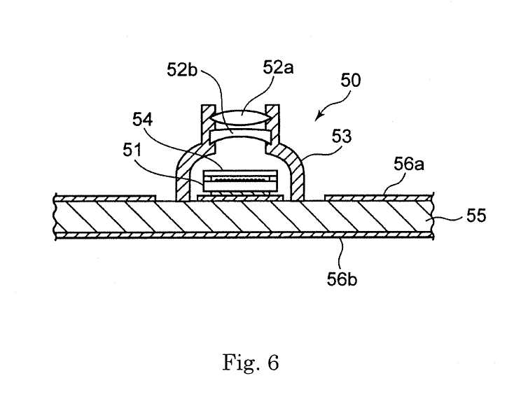

FIG. 7 is a cross-sectional view illustrating a camera module in the related art which is manufactured by a wafer process.

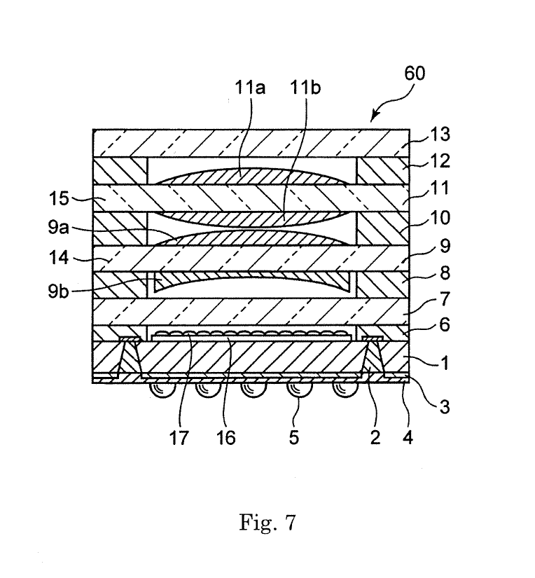

FIG. 8 is a cross-sectional view illustrating a camera module which includes a shielding lens tube with a configuration in the related art.

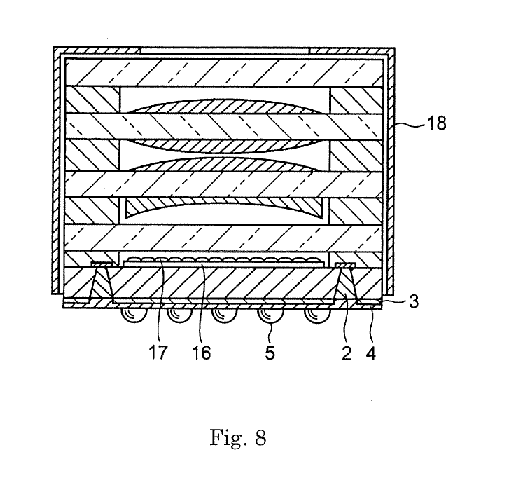

FIG. 9 is a diagram illustrating a state where a light shielding layer is partially formed on a spacer and a lens sheet in another configuration example of a camera module according to an embodiment of the invention.

FIGS. 10A to 10D are process diagrams schematically illustrating a method of coating a peripheral portion of a lens with a light shielding layer.

FIG. 11 is a cross-sectional view illustrating another configuration example of a camera module which includes a light shielding film according to an embodiment of the invention.

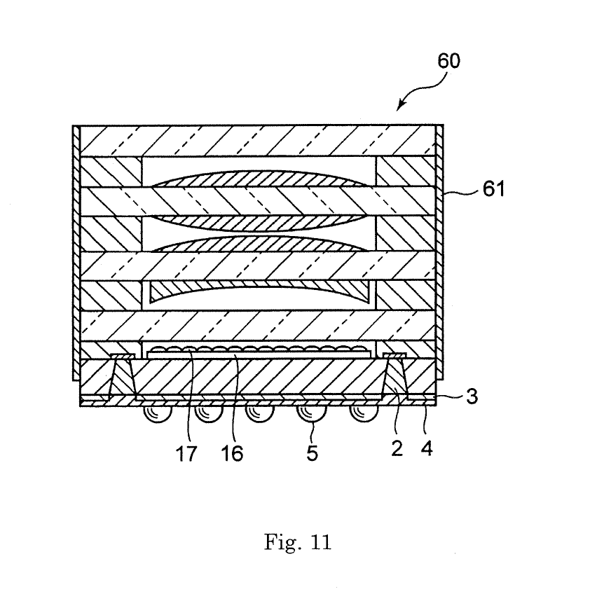

FIGS. 12A to 12E are cross-sectional process diagrams schematically illustrating an example of a camera module manufacturing process according to an embodiment of the invention.

FIGS. 13A to 13D are cross-sectional process diagrams schematically illustrating an example of a camera module manufacturing process according to an embodiment of the invention.

FIG. 14 is a cross-sectional view illustrating another configuration example of a camera module according to an embodiment of the invention.

### DETAILED DESCRIPTION OF THE INVENTION

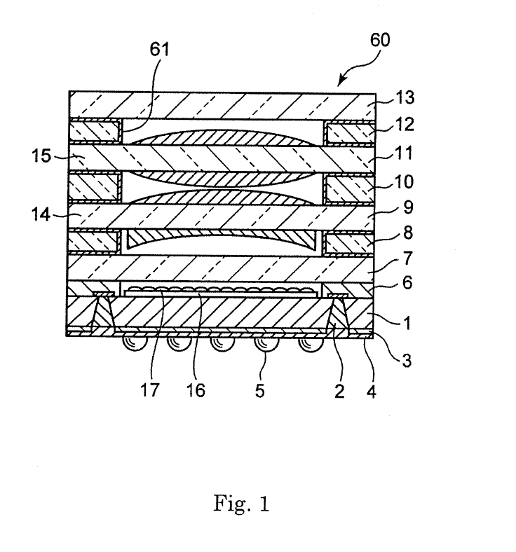

Hereinafter, a camera module according to an embodiment of the invention will be described with reference to FIG. 1.

In a camera module 60 according to the present embodiment shown in FIG. 1, a light shielding layer 61 for flare prevention is formed on inner side walls of spacers 8, 10 and 12 by electroless plating. The plating material may be an electroless plating layer of a single metal which is selected from nickel, chromium, cobalt, iron, copper, gold and the like, or may be an electroless plating layer of an alloy which is selected from combinations of nickel-iron, cobalt-iron, copper-iron and the like. Further, a metal of copper or the like may be subjected to electroless plating, and its front surface may be then chemically treated and oxidized to obtain a metal compound, to thereby achieve a metallic light shielding layer with a low optical reflectance on its front surface.

It is preferable that the light shielding layer 61 formed by the electroless plating have a high light shielding performance of an optical density (OD) of 2.0 or more in a Macbeth densitometer, and thus, metal may be used as the light shielding layer 61. In the light shielding layer formed by metal plating which is normally used, in order to realize the optical density of 2.0 or more, it is sufficient if the thickness thereof is 0.1 to 1.0 μm.

Further, the light shielding layer 61 which covers an inner side wall or a side wall of the camera module 60 according to the present embodiment may be formed of black paint by a spray coating method or a dipping method. The light shielding layer 61 which is formed of the paint generally has a low reflection property on its front and rear surfaces, and may be thus used as a light shielding layer. The thickness of the light shielding layer 61 formed by the coating method is approximately 2.0 to 50 μm. Further, the light shielding layer 61 may be formed by a different forming method, for example, a sputter deposition method. The light shielding layer 61 may also be formed of a single metal material such as chromium metal, or the front and rear surface of the light shielding layer 61 may be formed as a light shielding layer having a low light reflection property by introducing a reactant gas such as oxygen gas or nitrogen gas to a sputter deposition atmosphere. If the thickness of the light shielding film formed by the sputter deposition method is 0.1 to 1.0 μm, it is possible to achieve a sufficient light shielding property.

In FIG. 1, the light shielding layer 61 is formed on the inner side walls of the spacers 8, 10 and 12, and also is formed on upper and lower surfaces thereof. According to this configuration, in a case where the light shielding layer is formed on the upper and lower surfaces of the spacers, light which is incident at an angle is blocked, to thereby prevent the flare phenomenon. Further, this configuration is necessary for a manufacturing process.

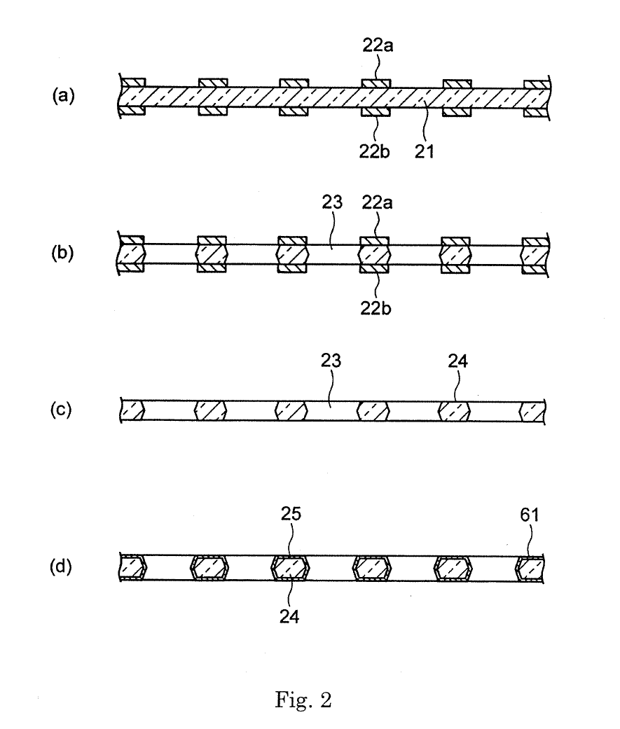

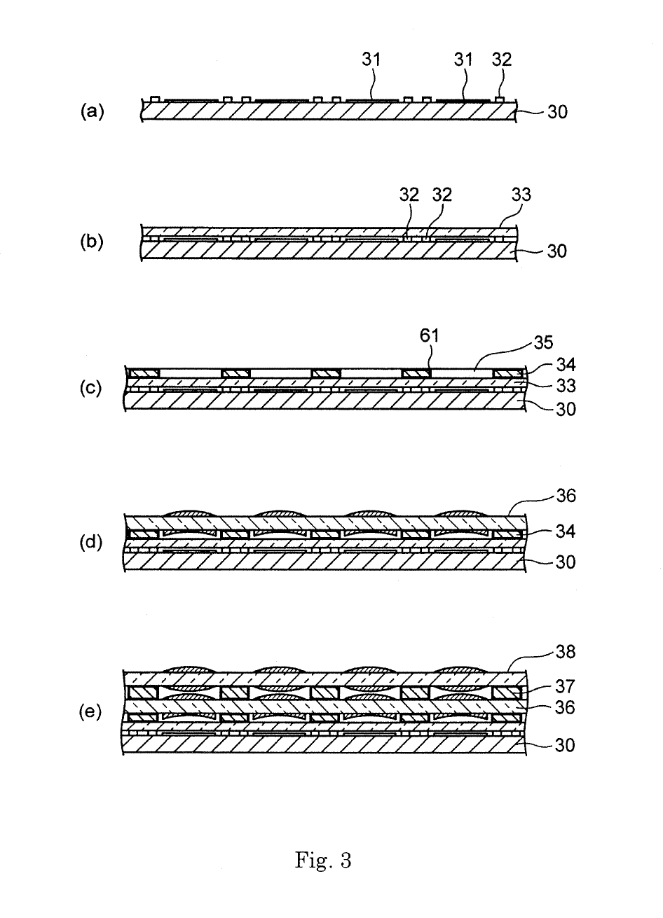

Further, another configuration example of the camera module according to the present embodiment will be described in detail with reference to FIGS. 2A to 2D and FIGS. 3A to 3E.

A material glass plate 21 shown in FIG. 2A serves as a base material of a spacer, and its material is borosilicate glass, alumina-silicate glass, soda-lime glass or the like, for example. The size thereof has the same diameter as a silicon wafer which is used to manufacture a solid-state imaging device, for example, 20 to 30 cm. It is preferable that the thickness thereof be approximately 0.4 mm to 2.0 mm. In a case where the thickness is thinner than 0.4 mm, it is difficult to process the material glass plate 21 by a processing and manufacturing device in the wafer process due to lack of solidity as a substrate material, which defines the lower limit of the thickness. The upper limit of the thickness is determined by a balance between the thickness of the lens used in a post-process and a lens design for securing a necessary optical path length. However, since it is preferable that the camera module according to the present embodiment be a thin type, it is preferable that the thickness of the glass plate 21 be a thickness determined in consideration of the optical properties and solidity.

Resist films 22a and 22b having hydrofluoric acid resistance are formed on opposite surfaces of the glass plate 21 in a patterned manner. When seen from the top, the resist films 22a and 22b form a grating pattern. It is preferable that the shape and size of the grating pattern be the same as the size and pitch of the solid-state imaging device formed on the silicon wafer in a different process.

Further, as the resist films 22a and 22b, a photosensitive resin having hydrofluoric acid resistance which is commercially available may be used. If the photosensitive resin is used, it is possible to form the resist films 22a and 22b with a desired pattern on the opposite surfaces of the glass plate 21 by a series of photolithography processes, that is, coating, pattern exposure, development and thermal curing. It is practical to employ a two-layer configuration of a metal layer and the photosensitive resin, which is obtained by patterning a thin film of metal such as nickel, silver or chromium under the organic photosensitive resin, to be used as the resist films.

Next, the glass plate 21 is wet-etched by a hydrofluoric acid based etching liquid. As the hydrofluoric acid based etching liquid, any one of mixtures of hydrofluoric acid and ammonium fluoride, hydrofluoric acid and sulfuric acid, hydrofluoric acid and hydrochloric acid, hydrofluoric acid and phosphoric acid, and hydrofluoric acid and ammonium salt, instead of hydrofluoric acid alone may be preferably used. By using the etching liquid based on the mixture, it is possible to increase the etching speed and to enhance smoothness of the etching surface, compared with hydrofluoric acid alone. In any case, this may be used as an aqueous solution. FIG. 2B shows a state where the etching process is completed. The portion where the resist films 22a and 22b are not disposed is dissolved to form an opening portion 23.

Then, as shown in FIG. 2C, by being in contact with an alkaline aqueous solution such as sodium hydroxide, potassium hydroxide or sodium carbonate, the resist films 22a and 22b are separated. The completed result forms a spacer 24 of a grating pattern, having the plural opening portions through the etching process, in which a portion where the original thickness of the material glass plate 21 is maintained forms the height of the spacer.

Next, alight shielding layer 25 is formed on the entire surface of the spacer 24. As a method of forming the light shielding layer 25, there are an electroless plating method and a black colored resin coating method.

Since it is preferable that the light shielding layer 25 to be formed have a high light shielding performance of the optical density of 2.0 or more in the Macbeth densitometer, it is preferable to use a metal film as the light shielding layer 25. In order to realize the light shielding layer of the optical density of 2.0 or more in a metal plating layer which is normally used, it is sufficient to use a thickness of 0.1 to 1.0 μm.

The electroless plating may basically include a known metal electroless plating method or a known alloy electroless plating method. In the process of the electroless plating, a series of processes of cleansing, delipidation, sensitization, activation and plating operations is performed.

Since the camera module according to the present embodiment is built-in in a device such as a mobile phone in the post-process, it is preferable that the metal light shielding layer formed on the inner side wall through the electroless plating be attached to the inner side wall by a strong adhesive force. Thus, it is preferable to select a plating method with high attachment strength to the glass surface, as the electroless plating method. As an example, in the case of nickel electroless plating, a process using an aqueous solution of alkaline metal salt of hypophosphoric acid such as sodium hypophosphite or potassium hypophosphite is performed after the processes of the delipidation, sensitization and activation operations, and then, the main operation of electroless plating is performed.

By performing the electroless plating, as shown in FIG. 2D, the light shielding layer 25 through the electroless metal or alloy plating is formed on the entire surface of the spacer 24.

Further, the light shielding layer 25 may be formed of black paint by a spray coating method or a dipping method. The light shielding layer 25 which is formed of the paint generally has a low light reflection property on its front and rear surfaces. Here, as the black paint, a black colored photosensitive resin composition obtained by adding black pigments or dyes or plural colors of pigments or dyes to a photosensitive resin composition may be used. The thickness of the light shielding layer 25 which is formed by such a coating method is approximately 2.0 to 20 μm.

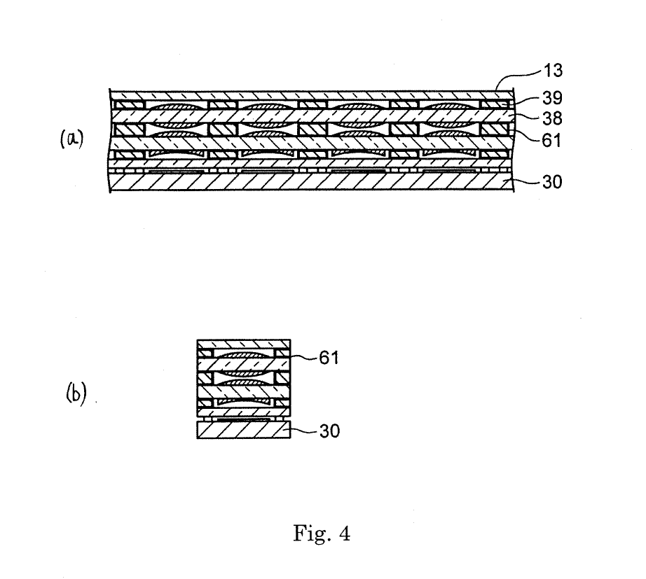

Subsequently, a process of combining a solid-state imaging device, a lens sheet and the like to complete a camera module will be described with reference to FIGS. 3A to 3E, FIGS. 4A and 4B.

This process may be continuously performed by a wafer process. That is, as shown in FIG. 3A, plural solid-state imaging devices 31 is formed on a silicon wafer 30 having a diameter of 20 to 30 cm. On a light receiving surface of each solid-state imaging device 31, a color filter for color separation, a micro-lens for light condensation to a light receiving section, and the like are generally formed. Further, a BGA for an external connection terminal is installed on a rear surface of the wafer (not shown). A dam 32 is formed on the front surface of each solid-state imaging device 31 to surround the solid-state imaging device 31. The thickness of the dam 32 is approximately 50 μm.

Next, as shown in FIG. 3B, a sealing glass plate 33 is attached to the dam 32. The sealing glass plate 33 is a glass plate having the same diameter as that of the silicon wafer 30. The material of the dam 32 has an adhesive property with respect to the sealing glass plate 33. At the time of attachment, an adhesive agent is coated on a lower surface of a first spacer sheet 34 with a thickness of about 5 to 10 μm by a roll coating method. According to the roll coating method, it is possible to selectively coat the adhesive agent on the lower surface of the first spacer sheet 34. Further, even though a part of the adhesive agent reaches an inner side wall of the opening portion 35, the amount thereof is small, and thus, if it does not block incident light beams, there is no problem in practice. Similarly, in the case of a second spacer sheet 37 and a third spacer sheet 39 which are later attached in a similar way, there is no particular problem.

Then, as shown in FIG. 3C, the first spacer sheet 34 which is manufactured in advance is attached to an upper surface of the sealing glass plate 33 so that their positions match each other. The light shielding layer described with reference to FIGS. 2A to 2D is formed on the entire surface of the first spacer sheet 34.

Then, as shown in FIG. 3D, a first lens sheet 36 is layered on the upper surface of the first spacer sheet 34. In the layering operation, an adhesive agent is coated in advance on the upper surface of the first spacer sheet 34 by the roll coating method. Its thickness is approximately 5 to 10 μm, which is the same as shown in FIG. 3C. The first lens sheet 36 is a concave lens.

Next, as shown in FIG. 3E, the second spacer sheet 37 and a second lens sheet 38 are layered on the first lens sheet 36 to adhere to each other. The reason why the second spacer sheet 37 mediates the layering and adhesion is the same as that of the first spacer sheet 34 as described above. Subsequently, as shown in FIG. 4A, a third spacer sheet 39 and a cover plate 13 are layered on the second lens sheet 38 to adhere to each other. The state shown in FIG. 4A is a state where the plural lens sheets or transparent glass plates is layered on the silicon wafer 30 and the plural camera modules is manufactured.

Finally, in order to separate the respective camera modules into individual pieces, the camera modules are vertically cut from the cover glass plate 13 to the silicon wafer by a dicing device. The cutting position corresponds to a central line of the grating pattern in the spacer sheets 34, 37 and 39. By performing cutting along the position, a camera module 60 shown in FIG. 4B is obtained. The camera module 60 shown in FIG. 1 is an enlarged example of the camera module 60 in FIG. 4B.

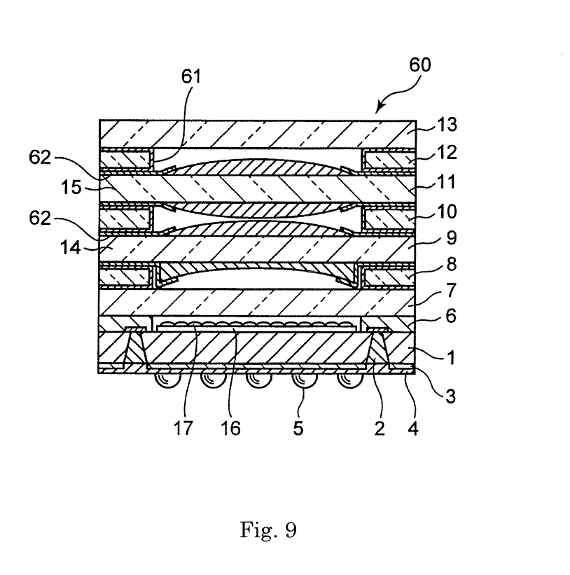

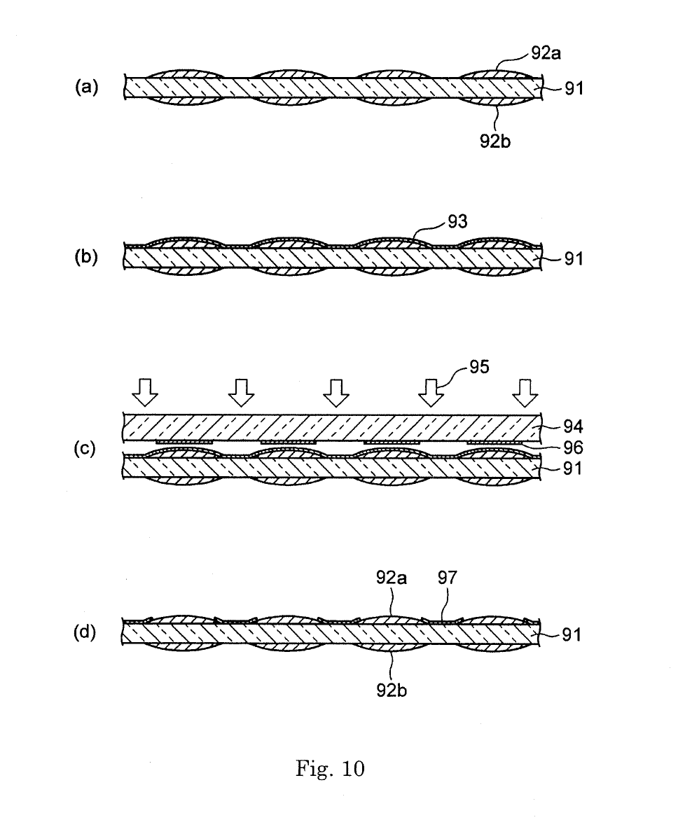

The invention may have some modified configuration examples. For example, an example in FIG. 9 shows a camera module in which a light shielding layer 61 is formed on spacers 8, 10 and 12 and a light shielding film 62 is formed in necessary portions of a first lens sheet 14 and a second lens sheet 15. In the example shown in FIG. 9, in order to enhance the flare prevention effect, the light shielding film 62 is formed up to peripheral portions of the lenses of the lens sheets 14 and 15. The lens sheet including the light shielding film 62 having the above-described configuration may be manufactured by processes shown in FIGS. 10A to 10D.

That is, as shown in FIG. 10A, a lens sheet 90 in which plural lenses 92a and 92b made of transparent resin is formed on opposite surfaces of a glass lens substrate 91 is prepared. Then, a black colored photosensitive resin composition is coated on the front surface of the lens sheet 90 to form a photosensitive black resin layer 93. The black colored photosensitive resin composition is obtained by dispersing or adding black pigments or dyes or plural colors of pigments or dyes to the photosensitive resin, which includes coloring material of dyes or pigments, solvent-soluble resin having a relatively low molecular weight, photopolymerizable monomers or oligomers, a photopolymerizable initiator and solvent, for example.

Next, as shown in FIG. 10C, irradiation of exposure light 95 is performed through an exposure mask 94. Alight shielding film 96 having a desired pattern is disposed on the exposure mask 94. An area where the photosensitive black resin layer 93 is to be removed is light-shielded so as not to be subject to the irradiation of the exposure light 95, and the light shielding film is formed in a lens area which should function as a lens. Further, a transmission pattern of the exposure light is formed in the peripheral portion of the lens. In FIG. 10C, the black colored photosensitive resin composition is a negative photosensitive resin, and only a portion which is subject to the light irradiation shows a light curing characteristic.

Next, as shown in FIG. 10D, only the portion where the black colored photosensitive resin compound is light-cured remains through development using a solvent or an alkaline aqueous solution, and then, a thermal curing process is performed to obtain a light shielding layer 62. The thermally cured light shielding layer 62 maintains its shape even through the subsequent exposure or developing process, so that the light shielding layer 62 is formed in the peripheral portion of the lenses 92a and 92b. Accordingly, in the state shown in FIG. 10D, the same process may also be performed with respect to the rear surface of the lens substrate 91, to thereby form the light shielding layer 62 on the rear surface of the lens substrate 91. In this way, the lens sheet 38 having plural lens sheets 15 which forms the camera module shown in FIG. 9 is obtained.

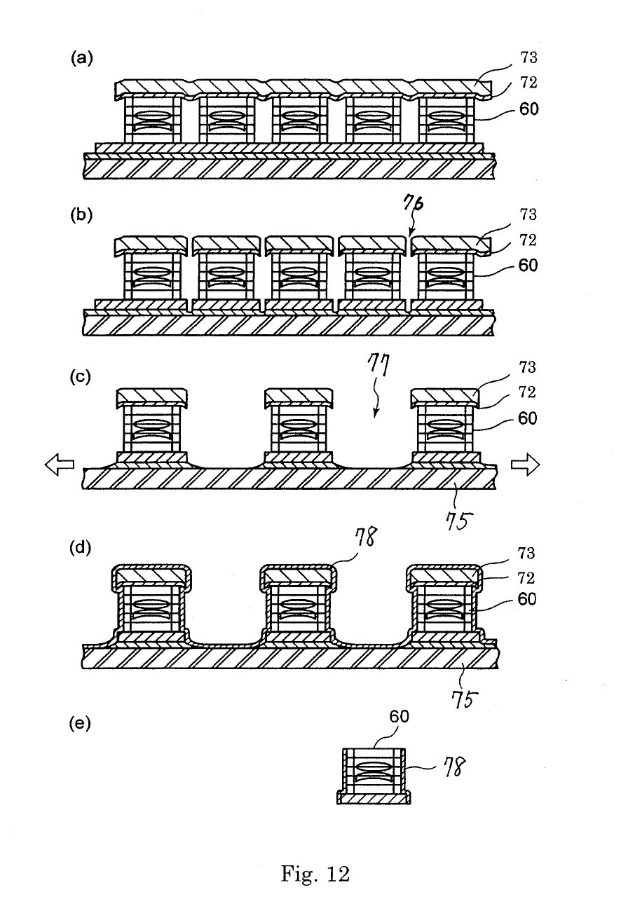

Further, a method of manufacturing a camera module according to another configuration example of the invention will be described in detail with reference to FIGS. 12A to 12E which are process diagrams.

As shown in FIG. 12A, the plural camera modules 60 is manufactured in a state of being attached to one silicon wafer 21 and is cut into individual pieces, in a manufacturing process. Immediately before the cutting process, as shown in FIG. 12A, an easily detachable protection film 72 is attached onto the upper surface of the plural camera modules 60 which is manufactured in the state of being attached to the silicon wafer 21 to cover the upper surfaces of the camera modules 60. In a case where the strength of the easily detachable protection film 72 is not sufficient, an adhesive tape 73 may be layered for reinforcement. Further, an extensible film 75, such as a polyethylene or vinyl chloride resin film, having an adhesive layer 74 is attached to the lower surface thereof, for example.

FIG. 12B shows a state where a cutting groove 76 is formed between the respective camera modules 60 by a dicing device or the like. As described above, the easily detachable protection film 72 prevents the upper surface of the camera module 60 from being contaminated due to a coolant used in cutting or glass fragments generated in cutting.

Subsequently, as shown in FIG. 12C, by applying a force to extend the extensible film 75 outward as indicated by an arrow in the figure, the width of the cutting groove 76 is enlarged to form a gap 77. In this state, since the camera modules 60 which are cut into individual pieces have a wide interval between side walls thereof, it is possible to easily perform cleansing or the like of this portion.

Next, an electroless plating process in the state shown in FIG. 12C, that is, a series of processes of cleansing, delipidation, sensitization, activation and plating operations is performed.

As an example, in the case of nickel electroless plating, a process through an aqueous solution of alkaline metal salt of hypophosphoric acid such as sodium hypophosphite or potassium hypophosphite is performed after the delipidation operation, the sensitization operation and the activation operation, and then, the electroless plating operation is performed.

Further, since it is preferable that the metal light shielding layer obtained through the electroless plating to the side wall in the camera module according to the present embodiment be attached to the side wall by a strong adhesive force, it is preferable to select a plating method with high attachment strength to the glass surface, as the electroless plating.

By performing the electroless plating, as shown in FIG. 12D, the light shielding film 78 obtained through metal or alloy electroless plating is formed on the entire surface of the side wall of the camera module 60, the easily detachable protection film 72, the adhesive tape 73 and the extensible film 75.

However, thereafter, by detaching the respective camera modules 60 from the extensible film 75, and then, by detaching the easily detachable protection film 72 and the adhesive tape 73, the camera modules 60 which are independently separated into individual pieces as shown in FIG. 12E are obtained, and thus, the light shielding film 78 through the electroless plating is formed only on the side wall thereof.

Further, in the state shown in FIG. 12C, since the interval between the respective camera modules 60 is enlarged by the gap 77, the light shielding film 78 may be formed on the side wall by the sputter deposition method. Further, a coating film with black dyes may be formed on the side wall of the camera module 60 by the spray method or the dipping method, to obtain the light shielding film 78.

After obtaining the configuration shown in FIG. 12D by the sputter deposition method or the coating method, the easily detachable protection film 72, the adhesive tape 73 and the extensible film 75 which are attached to the upper and lower surfaces of the camera module 60 may be removed by the same process.

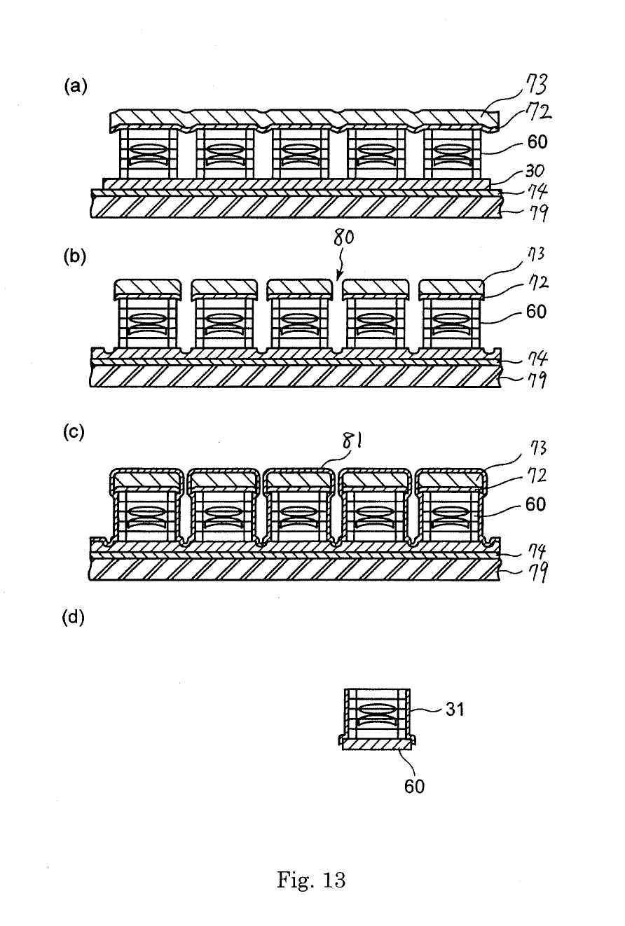

Further, another camera module manufacturing method according to the present embodiment will be described with reference to FIGS. 13A to 13D.

In this manufacturing method, cutting is performed only up to an intermediate position of the thickness direction of the silicon wafer 30 of the camera module 60 without enlarging the gap between the respective camera modules, and then, the electroless plating is performed. As shown in FIG. 13A, the plural camera modules 60 is manufactured in a state of being attached to one silicon wafer 30, and is then cut into individual pieces. Before the cutting process, as shown in FIG. 13A, the easily detachable protection film 72 is attached onto the upper surfaces of the plural camera modules 60 which is manufactured in the state of being attached to the silicon wafer 30 to cover the upper surfaces of the camera modules 60. In a case where the strength of the easily detachable protection film 72 is not sufficient, the adhesive tape 73 may be layered to reinforce the strength. In order to enhance the strength, a backing film 79, such as a polyester or vinyl chloride resin film, having an adhesive layer 74 is attached to the lower surface thereof. The backing film 79 is used to adhesively support the separated camera modules 60 on the backing film 79 even though the silicon wafer 30 is half-cut in the subsequent process.

FIG. 13B shows a state where a cutting groove 80 is formed between the respective camera modules 60 by the dicing device or the like. Here, the silicon wafer 30 is half-cut, and is not completely cut. Here, it is preferable that the width of the cutting groove 80 in the present embodiment be wider than the width of the cutting groove 76 formed in the embodiment described with reference to FIGS. 2A to 2D.

Next, in the state shown in FIG. 13B, the series of processes of cleansing, delipidation, sensitization, activation and plating operations which is the electroless plating process is performed. By performing the electroless plating through this process, as shown in FIG. 13C, a light shielding film 81 obtained through electroless single metal or alloy plating is formed on the entire surface of the side wall of the camera module 60, the easily detachable protection film 72 and the adhesive tape 73.

Then, the silicon wafer 30 is completely cut in the thickness direction, the separated camera modules 60 are detached from the backing film 79, and then, the easily detachable protection film 72 and the adhesive tape 73 are detached therefrom, to obtain the independently separated individual camera modules 60 as shown in FIG. 13D. The light shielding film 81 through the electroless plating is formed on the side wall of the camera module 60. In this process example, since the cutting process is performed after the electroless plating process to separate the camera modules 60 into individual pieces, the light shielding film 81 obtained through the electroless plating does not reach up to the silicon wafer surface which is the bottom of the camera module 60.

Hereinafter, specific examples of the invention will be described.

In this description, the composition ratio in the examples refers to the mass ratio, unless otherwise mentioned.

### Example 1

(1) Manufacturing of Spacer Sheet

With respect to an alumina-borosilicate glass wafer (ZnO 21%, Al₂O₃ 5%, B₂O₃ 40%, SiO₂ 14%) of a thickness of 0.5 mm and a diameter of 20 cm, a chromium metal layer of a thickness of 200 nm was sputter-deposited on opposite surfaces thereof, and then, acryl-epoxy based photosensitive resin was coated thereon with a thickness of 2 μm. Then, pattern exposure and developing were performed in a state where the opposite surfaces were positioned, and then, thermal curing was performed. The shape of this resist film is a grating pattern, and its shape and pitch match the shape and pitch of plural solid-state imaging devices formed on the silicon wafer. The lower chromium metal layer was etched by the resist film to form an etching resistant film of two layers of the chromium metal layer and the resist film. The shape of the etching resistant film was a grating pattern in which a portion to form an etching opening portion was opened, when seen from the top.

Next, dipping was performed at normal temperature using a mixed etching liquid of 10% hydrofluoric acid and 10% NH₄OH, to perform glass etching. Etched concave portions were formed from the opposite surfaces of the glass wafer and were connected to each other, to form the opening portion. Then, the resist film and the chromium layer were dissolved and removed to obtain the spacer sheet 24 as shown in FIG. 2C.

Then, the spacer sheet 24 which was delipidated and cleansed with water was dipped for four minutes in an aqueous solution (25° C.) obtained by dissolving 5 g of stannic chloride and 5 ml of 35 weight % hydrochloric acid in 1 litter of water, for a sensitization operation, was cleansed with flowing water for 10 seconds, and then, was dipped at normal temperature for four minutes in an aqueous solution obtained by dissolving 0.1 g of palladium chloride (PdCl₂) and 0.2 ml of hydrochloric acid in 1 litter of water, for an activation process. After the cleansing, the spacer sheet 24 was dipped for 10 minutes at a temperature of 50° C. using “SUMER S-680” (Japan Kanigen Co., Ltd.) as an electroless nickel plating solution, to perform the electroless plating. Thereafter, the spacer sheet 24 was cleansed with water and was subject to a hot air drying for 30 seconds at a temperature of 80° C., to thereby obtain the spacer sheet 24 in which the electroless plating layer was formed on the entire surface thereof. The electroless nickel plating layer had an OD value of 5.0±0.5 in the Macbeth densitometer, and its attachment strength was satisfactory.

(2) Assembly of Camera Module

Description will be made with reference to FIGS. 3A to 3E, FIGS. 4A and 4B. Plural solid-state imaging devices 31 attached to a silicon wafer of a thickness of 0.25 mm and a diameter of 20 cm, as shown in FIG. 3A, was prepared. By using a dam 32 installed on an upper surface of the solid-state imaging device 31 as a spacer and an attachment layer, a sealing glass plate 33 having a thickness of 0.4 mm and a diameter of 20 cm was adhered to the upper surface thereof (see FIG. 3B). Then, an acryl-epoxy based adhesive agent was coated with a thickness of about 5 μm by a roll coating method on the lower surface of the first spacer sheet 34 with the light shielding layer manufactured in FIGS. 2A to 2D. The adhesive agent was coated only on the lower surface of the first spacer sheet 34. In this state, the first spacer sheet 34 was attached to match the position of the solid-state imaging device 31 (see FIG. 3C). Next, on the upper surface of the thick portion of the first spacer sheet 34, an adhesive agent was coated at about 5 μm by the roll coating method, and the first lens sheet 36 of a concave lens shape was layered on the first spacer sheet 34 for attachment. At this time, alignment of the respective lenses of the first lens sheet 36 and light receiving surfaces of the solid-state imaging device 31 was performed (see FIG. 3D). Subsequently, using the same method, the second spacer sheet 37, and the second lens sheet 38 were layered and attached thereto (see FIG. 3E), and then, the third spacer sheet 39 and the cover glass plate 13 were attached thereto (see FIG. 4A).

Finally, a cutting groove was formed from the front surface by a dicing device using a resin blade of 450 mesh, using the position of the central portion of the spacer sheet as a cutting line. Then, the respective camera modules were separated, to thereby obtain a completed product of a camera module as shown in FIG. 4B.

### Example 2

In a similar way to Example 1, a spacer sheet in FIG. 2C was obtained by chemical etching using a hydrofluoric acid based etching liquid with respect to an alumina-borosilicate glass wafer (ZnO 21%, Al₂O₃ 5%, B₂O₃ 40%, SiO₂ 14%) of a thickness of 0.5 mm and a diameter of 20 cm. In this regard, the same operations as those of Example 1 were performed as delipidation, sensitization and activation operations which are a pre-process of the electroless plating. Thereafter, using a variety of electroless metal plating solutions mentioned in the following description, an electroless plating layer which is made of a single metal or alloy was formed on the entire surface of the spacer sheet to obtain the spacer sheet with a light shielding layer. Any light shielding layer had an OD value of 3.0 or more in the Macbeth densitometer.

### A. Electroless Copper Plating Solution

| | |
|---|---|
| Copper sulfate | 35 g/l |
| Sodium tartrate | 175 g/l |
| Sodium hydroxide | 50 g/l |

Addition of 100 ml of 37 weight % formaldehyde pH 11.5, temperature of 24° C., dipping time of 15 minutes

### B. Electroless Cobalt Plating Solution

| | |
|---|---|
| Cobalt sulfate | 0.07 mol/l |
| Sodium hypophosphite | 0.2 mol/l |
| Sodium citrate | 0.2 mol/l |
| Ammonium sulfate | 0.6 mol/l |

pH 9.5, temperature of 90° C., dipping time of 20 minutes

### C. Electroless Nickel-Iron Alloy Plating Solution

| | |
|---|---|
| Vinyl chloride | 0.056 mol/l |
| Ammonium ferrous sulfate | 0.020 mol/l |
| Potassium sodium tartrate | 0.2 mol/l |
| Sodium hypophosphite | 0.094 mol/l |
| Ammonia water | 3.6 mol/l |

Temperature of 75° C., dipping time of 20 minutes

The obtained spacer sheet may be used as a camera module spacer in a similar way to Example 1. As a result, a camera module having a flare prevention light shielding layer in the inner wall thereof was obtained.

### Example 3

In a similar way to Example 1, a spacer sheet in FIG. 2C was obtained by chemical etching using a hydrofluoric acid based etching liquid with respect to an alumina-borosilicate glass wafer of a thickness of 0.5 mm and a diameter of 20 cm.

Next, a coating film was formed on the entire surface by the spray coating method. The spray coating method is a method of atomizing paint by jet flow of compressed air transferred from a compressor for coating. An air pressure during operation was 1 to 5 kg/cm². The spacer sheet as shown in FIG. 2C was placed on a rotary table and a spray gun was installed at an angle of 20° to 70° in a position spaced from the spacer sheet by 10 to 100 cm for ejection of the paint. The rotary table was slowly rotated and the coating operation was performed on the side wall of the camera module so that the thickness of the coating film became about 20 μm. Thereafter, the spray sheet was turned over to coat the paint by performing the same coating operation.

Then, drying and curing were performed for about 20 minutes at a temperature of 80° C. By performing the spray coating in this way, the light shielding film 61 was formed on the entire surface thereof as shown in FIG. 2D. As the black paint, a black paint “Riopol Black” (made by TOYO INK CO., LTD, acryl urethane resin based paint) was used. The coated light shielding film had an OD value of 4.0±0.5 in the Macbeth densitometer, and its adhesion strength was satisfactory. The obtained spacer sheet may be used as a camera module spacer in a similar way to Example 1. As a result, a camera module having a flare prevention light shielding layer in the inner wall thereof was obtained.

### Example 4

The present example is an example in which the light shielding layer is formed up to the periphery of the lens of the lens sheet, in addition to the attachment of the light shielding layer to the spacer sheet.

(1) Preparation of Black Colored Photosensitive Composition for Light Shielding Layer

Acryl resin (acryl resin obtained by dissolving 20 parts by weight of methacrylic acid, 15 parts by weight of hydroxylethyl methacrylate, 10 parts by weight of methyl methacrylate and 55% parts by weight of butyl methacrylate in 300 parts by weight of ethylcellosolve, adding 0.75 parts by weight of azobis nitrile under a nitrogen atmosphere, and reacting for 5 hours at 70° C.) was diluted with ethylcellosolve to be 20% by weight of resin density. The diluted resin (80 g), 20 g of carbon black and 0.2 g of a dispersing agent (fluorochemical surfactant) were added and were dispersed for three hours while performing cooling by a bead mill disperser. Trimethylolpropane triacrylate (3.9 g) which is a photopolymerizable monomer and 0.8 g of piperonyl-s-triazine which is a photoinitiator were added to 100.2 g of the colored resin liquid. The resultant was diluted to 7% by weight of solid content with ethylcellosolve as a solvent, and was mixed to prepare a black colored photosensitive composition for forming a light shielding layer.

(2) Manufacturing of Light Shielding Layer

The black colored photosensitive composition for a light shielding layer was spin-coated on a lens sheet on which plural lenses was formed, and was prebaked for 20 minutes at 70° C., to form a photosensitive black paint film 93 of a thickness of 3.0 μm on the front surface of the resist sheet (see FIG. 10B).

Then, exposure was performed using an exposure mask 94 on which the light shielding film 93 blocking light corresponding to the opening portion of the lens was formed by exposure light 95 from a light source of a high pressure mercury light (exposure amount of 150 mJ/cm²), development was performed by a 2.5% sodium carbonate solution, and then, water cleansing was performed. After water cleansing and drying, by performing post-baking for one hour at 150° C., a resist sheet in which the light shielding layer 97 was coated up to a peripheral portion of the lens was obtained (see FIG. 10C).

Subsequently, by performing the same operation as described above with respect to the rear surface of the glass sheet, the lens sheet in which a light shielding layer was coated up to a peripheral portion of the lens on the rear surface was obtained. It was confirmed that the OD value of the light shielding layer measured by the Macbeth densitometer was 3.0 or more and the light shielding layer had k of a high density in low surface reflectivity. The obtained lens sheet may be used as a camera module lens sheet in a similar way to Example 1. By using this camera module lens sheet and the spacer sheet on which the similar light shielding film was formed, it was possible to obtain a camera module having a flare prevention light shielding layer on the inner wall.

### Example 5

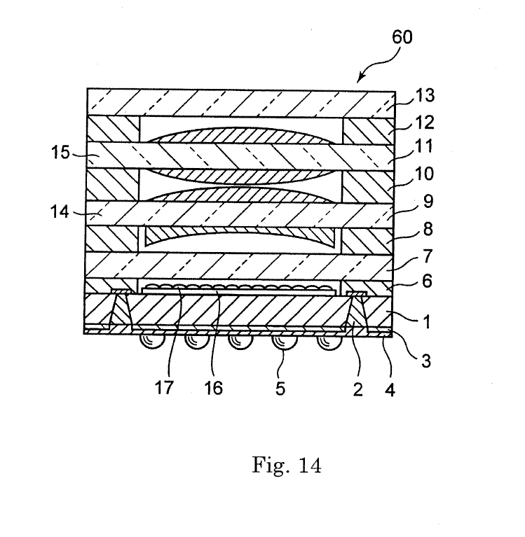

In a state where plural camera modules as shown in FIG. 14 was formed on a silicon wafer of a thickness of 0.25 mm and a diameter of 30 cm, a coating material “Silitect-II” (made by Controline Inc., USA) for an easily detachable coating film was coated on a front cover glass plate and was dried, to thereby obtain an easily detachable protection film 72. Next, an extensible film “5PV-224” (made by NITTO DENKO CORPORATION) in which an adhesive layer was installed on one surface of an extensible polyvinylchloride film was attached to the lower surface of the silicon wafer, to thereby obtain the state shown in FIG. 12A. Then, dicing was performed from a side of a front cover glass plate by a dicing device which included a resin blade of 450 mesh to form a cutting line, and then, end parts of the extensible film were extended to obtain the state where the interval 77 was formed between the pieces shown in FIG. 12C.

Subsequently, the side wall of the glass module 60 which was delipidated and cleansed with water was dipped for four minutes in an aqueous solution (25° C.) obtained by dissolving 5 g of stannic chloride and 5 ml of 35% by weight hydrochloric acid in one litter of water, for a sensitization operation, was cleansed for 10 seconds by flowing water, and then, was dipped for four minutes at normal temperature in an aqueous solution obtained by dissolving 0.1 g of palladium chloride (PdCl₂) and 0.2 ml of hydrochloric acid in one litter of water, for an activation operation. After water cleansing, dipping was performed for 10 minutes at a temperature of 50° C., using “SUMER S-680” (Japan Kanigen Co., Ltd.) as an electroless nickel plating solution, to perform the electroless plating. Thereafter, hot air drying was performed for 30 seconds at a temperature of 80° C. after water cleansing.

Then, by detaching the extensible film 75 attached to the rear surface of the camera module and the easily detachable protection film 72 attached on the front surface thereof, a solid-state imaging camera module 60 in which a light shielding film 81 through the electroless nickel plating was formed only on the side wall was obtained. The electroless nickel plating layer formed only on the side wall had the OD value of 5.0±0.5 in the Macbeth densitometer, and its attachment strength was satisfactory.

### Example 6

In a similar way to Example 5, plural camera modules formed on a silicon wafer was put in a consecutive sputter deposition device in the state shown in FIG. 12C. Chromium metal was used as a sputter target, and a semi-transparent chromium oxide nitride film of low light reflectivity was deposited at 0.01 μm by a reactive sputtering method in which oxygen gas and nitrogen gas were firstly introduced into a sputtering chamber. Then, a light shielding film of 0.12 μm was deposited with chromium metal, and a semi-transparent chromium oxide nitride film of low light reflectivity was deposited at 0.01 μm by a reactive sputtering method in which oxygen gas and nitrogen gas were finally introduced. The obtained light shielding film had low light reflectivity on the front and rear surfaces. Then, by detaching the extensible film 75 attached on the rear surface of the camera module and the easily detachable protection film 72 attached on the front surface thereof, a solid-state imaging camera module 60 in which the low reflective light shielding films of chromium oxide nitride/chromium/chromium oxide nitride were formed on only the side wall was obtained. The chromium-based light shielding film had an OD value of 3.0±0.5 in the Macbeth densitometer, and its attachment strength was satisfactory.

As described above, for the camera module according to the embodiment of the invention, in a case where plural camera modules is formed on one silicon wafer, by performing a series of operations of the wafer process, it is possible to form a flare prevention light shielding layer by a simple manufacturing method in a desired area such as an inner side wall or a side wall of the camera module.

(This application is incorporated by references which are Japanese application number 2009-236058, which is filed on Oct. 13, 2009, and Japanese application number 2009-264970, which is filed on Nov. 20, 2009)

What is claimed is:

1. A camera module comprising at least one lens sheet layered on a solid-state imaging device through a glass spacer, wherein an inner side wall and upper and lower surfaces or a side wall of at least the spacer are coated with a light shielding layer made of metal or black colored resin.

2. The camera module according to claim 1,
wherein at least a peripheral portion of a lens of the lens sheet is coated with the light shielding layer.

3. The camera module according to claim 1,
wherein the light shielding layer made of metal is formed by electroless plating or vacuum deposition.

4. The camera module according to claim 2,
wherein the light shielding layer made of metal is formed by electroless plating or vacuum deposition.

5. The camera module according to claim 1,
wherein the light shielding layer made of black colored resin is formed by spray coating or spin coating.

6. The camera module according to claim 2,
wherein the light shielding layer made of black colored resin is formed by spray coating or spin coating.

7. The camera module according to claim 1,
wherein the optical density of the light shielding layer is 2.0 or more.

8. The camera module according to claim 2,
wherein the optical density of the light shielding layer is 2.0 or more.

9. The camera module according to claim 3,
wherein the optical density of the light shielding layer is 2.0 or more.

10. The camera module according to claim 4,
wherein the optical density of the light shielding layer is 2.0 or more.

11. The camera module according to claim 5,
wherein the optical density of the light shielding layer is 2.0 or more.

12. The camera module according to claim 6,
wherein the optical density of the light shielding layer is 2.0 or more.

13. A manufacturing method of the camera module of claim 1 including at least one lens sheet layered on a solid-state imaging device through a glass spacer, the method comprising:
(a) attaching a detachable protection film onto upper surfaces of camera modules and adhering an extensible film which includes an adhesive layer onto lower surfaces of the camera modules;
(b) cutting the individual camera modules along a cutting line between the camera modules;
(c) enlarging a gap between the respective camera modules by extending the extensible film after the cutting;
(d) forming a light shielding layer on a side wall and upper and lower surfaces or the side wall of each of the camera modules where the gap is enlarged; and
(e) detaching the detachable protection film from the upper surfaces of the camera modules and the extensible film including the adhesive layer from the lower surfaces thereof.

14. A manufacturing method of the camera module of claim 1 including at least one lens sheet layered on a solid-state imaging device through a glass spacer, the method comprising:
(a) attaching a detachable protection film onto upper surfaces of the camera modules;
(b) cutting a silicon wafer, where the respective camera modules are formed, up to an intermediate portion of the silicon wafer in a thickness direction thereof, along a cutting line between the camera modules;
(c) forming a light shielding layer on a side wall and upper and lower surfaces or the side wall of each of the camera modules, which is cut and exposed, after cutting up to the intermediate portion of the silicon wafer in the thickness direction thereof; and
(d) performing full cutting along the cutting line between the camera modules and detaching the detachable protection film from the upper surfaces of the camera modules.
